(19) United States
(12) Patent Application Publication
(10) Pub. No.: US 2013/0116074 A1
(43) Pub. Date: May 9, 2013

(54) Sprocket wheel for bicycle

(71) Applicant: Chang Hui LIN, Chang Hua Hsien (TW)

(72) Inventor: Chang Hui LIN, Chang Hua Hsien (TW)

(21) Appl. No.: 13/373,204

(22) Filed: Nov. 8, 2011

(51) Int. Cl. B62M 9/00

(52) U.S. Cl. 474/152

(57) ABSTRACT

A sprocket wheel includes a number of supporting devices extended radially and inwardly from an outer peripheral rim, the supporting devices each include two protrusions extended radially and inwardly from the rim and offset from a center portion of the rim, and each of the protrusions include a number of levers for forming a number of spaces between the levers and include an inner end portion having an orifice formed therein, the inner end portions of the protrusions of each of the supporting devices are contact with each other, and the protrusions of the supporting devices are arranged in a stagger way relative to each other for suitably increasing the strength of the sprocket wheel and for dissipating the force to be applied to the sprocket wheel.

### BACKGROUND OF THE INVENTION

1. Field of the Invention

The present invention relates to a sprocket wheel, and more particularly to a sprocket wheel including an improved structure for increasing the strength of the sprocket wheel and for suitably dissipating the force to be applied to the sprocket wheel.

2. Description of the Prior Art

Typical sprocket wheels comprise a number of teeth formed or provided on the outer peripheral portion thereof, and an inner peripheral portion for attaching or mounting or securing onto the bicycle wheel hub, and for engaging with the chain and for speed changing purposes.

For example, U.S. Pat. No. 5,299,925 to Chang, U.S. Pat. No. 5,788,593 to Tiong, U.S. Pat. No. 5,971,878 to Leng, and U.S. Pat. No. 6,428,437 to Schlanger disclose several of the typical power transmission devices for the bicycles, each comprising a number of sprocket wheels each having a number of teeth formed or provided on the outer peripheral portion thereof, and an inner peripheral portion for attaching or mounting or securing onto the bicycle wheel hub, and for engaging with the chain and for speed changing purposes.

However, the sprocket wheels of the typical power transmission devices for the bicycles comprising a planar structure that may include a relatively lower or decreased strength and that may not be used to suitably dissipate the force to be applied to the sprocket wheel.

The present invention has arisen to mitigate and/or obviate the afore-described disadvantages of the conventional sprocket wheels for the bicycles.

### SUMMARY OF THE INVENTION

The primary objective of the present invention is to provide a sprocket wheel including an improved structure for increasing the strength of the sprocket wheel and for suitably dissipating the force to be applied to the sprocket wheel.

In accordance with one aspect of the invention, there is provided a sprocket wheel comprising an outer peripheral rim including a number of teeth provided on an outer peripheral portion thereof, and including a number of supporting devices extended radially and inwardly from the rim, the supporting devices each including two protrusions extended radially and inwardly from the rim and offset from a center portion of the rim, and each of the protrusions including a number of levers for forming a number of spaces between the levers and including an inner end portion having an orifice formed therein, the inner end portions of the protrusions of each of the supporting devices being contact with each other, and the protrusions of the supporting devices being arranged in a stagger way relative to each other for allowing the strength of the sprocket wheel to be suitably increased and for allowing the force to be applied to the sprocket wheel to be suitably dissipated.

The protrusions of each of the supporting devices may be symmetric to each other, or may be mirror-symmetric to each other. The protrusions of the supporting devices are formed integral with each other.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial plan schematic view of a sprocket wheel for attaching to a bicycle in accordance with the present invention, illustrating the operation of the sprocket wheel;

FIG. 2 is a perspective view of the sprocket wheel;

FIG. 3 is a plan schematic view of the sprocket wheel;

FIG. 4 is a cross sectional view of the sprocket wheel; and

FIG. 5 is a partial exploded view of the sprocket wheel.

### DETAILED DESCRIPTION OF THE PREFERRED EMBODIMENT

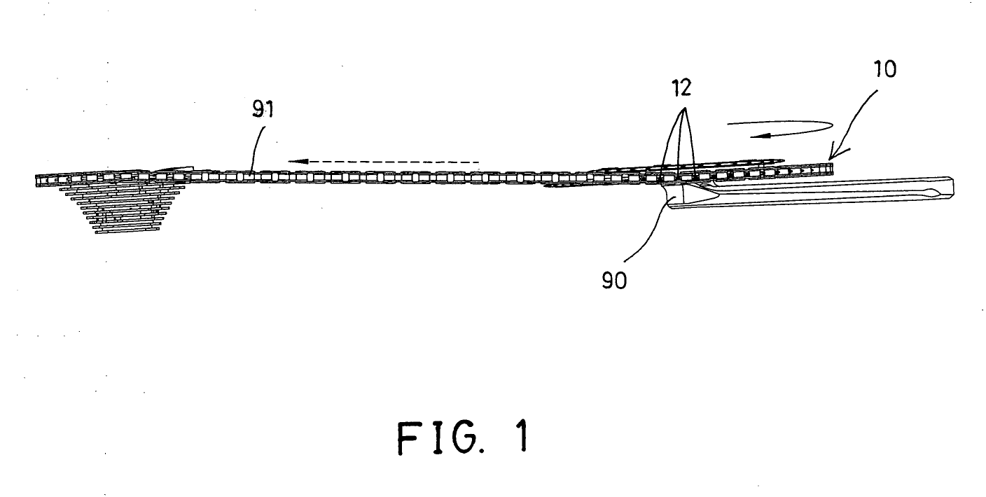

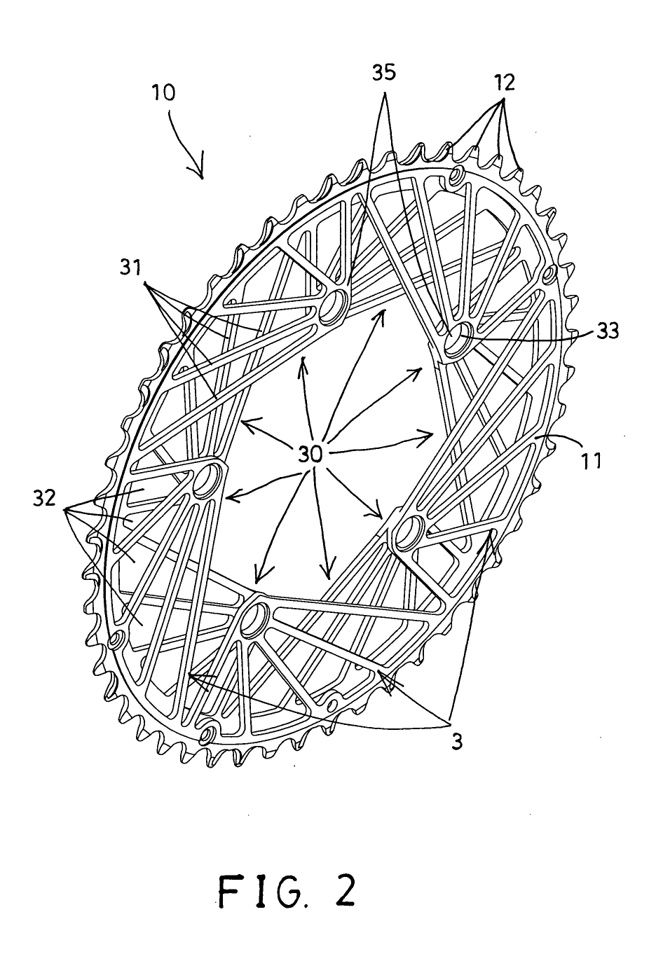

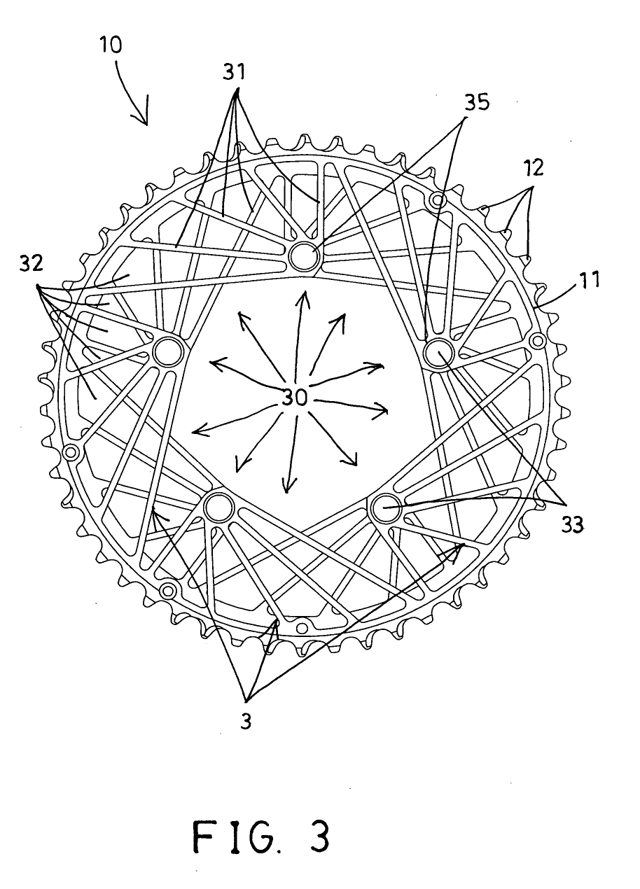

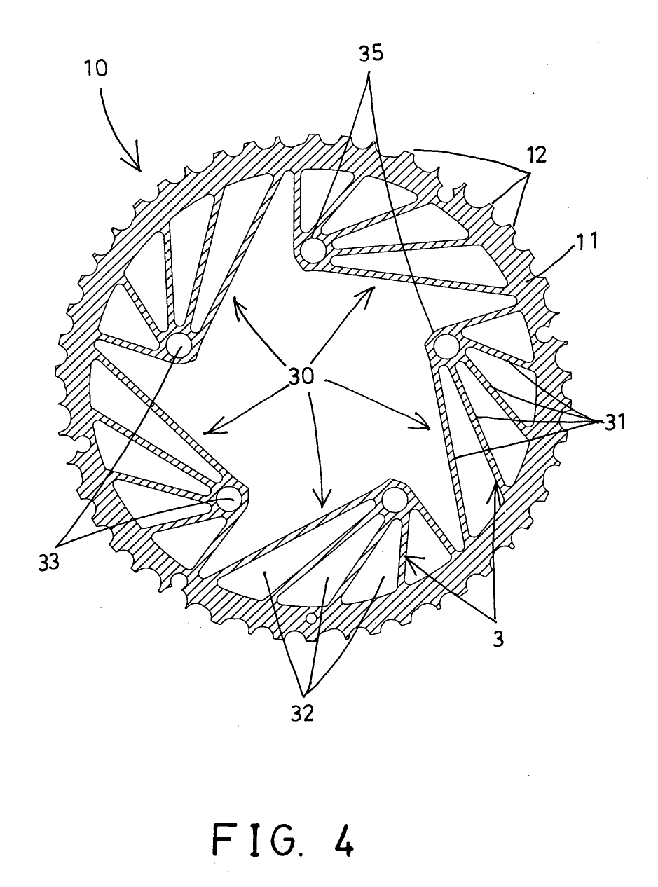

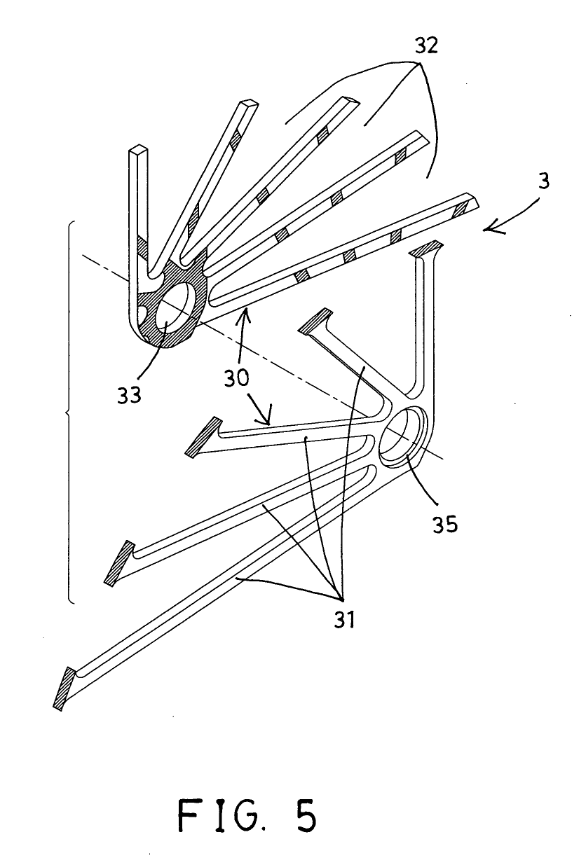

Referring to the drawings, and initially to FIG. 1, a sprocket wheel 10 in accordance with the present invention is provided for attaching or mounting or securing onto the bicycle wheel hub 90, and for engaging with the chain 91 and for speed changing purposes. As shown in FIGS. 2-5, the sprocket wheel 10 comprises an outer peripheral rim 11 including a number of teeth 12 formed or provided on the outer peripheral portion thereof, and a number of (such as five) bracing or supporting devices 3 attached or mounted or secured or coupled to the inner peripheral portion of the rim 11.

The supporting devices 3 each include two or a pair of extensions or protrusions 30 extended radially and inwardly from the rim 11, but not extended toward or offset from the center portion of the rim 11, and each of the protrusions 30 include a number of ribs or rods or levers 31 for forming or defining a number of openings or spaces 32 between the levers 31 and for weight reducing purposes, and include an orifice 33 formed therein for attaching or mounting or securing onto the wheel hub 90 of the bicycle.

The pair of protrusions 30 of each supporting device 3 are formed or provided or extended at opposite side, such as the front side and the rear side of the rim 11, and symmetric or mirror-symmetric to each other, and have an inner end portion 35 contact or engaged with each other or formed integral with each other, and have the orifice 33 formed in the inner end portion 35 thereof, and the protrusions 30 of the supporting device 3 are arranged in a stagger way relative to each other for suitably dissipating the force to be applied to the sprocket wheel and for suitably increasing the strength of the sprocket wheel 10. The pair of protrusions 30 of each supporting device 3 may also not symmetric or mirror-symmetric to each other. The sprocket wheel 10 may be formed integral with a milling or machining procedure.

Accordingly, the sprocket wheel in accordance with the present invention includes an improved structure for increasing the strength of the sprocket wheel and for suitably dissipating the force to be applied to the sprocket wheel.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A sprocket wheel comprising:
an outer peripheral rim including a plurality of teeth provided on an outer peripheral portion thereof, and including a plurality of supporting devices extended radially and inwardly from said rim,
said supporting devices each including two protrusions extended radially and inwardly from said rim and offset from a center portion of said rim, and each of said protrusions including a plurality of levers for forming a plurality of spaces between said levers and including an inner end portion having an orifice formed therein,
said inner end portions of said protrusions of each of said supporting devices being contact with each other, and said protrusions of said supporting devices being arranged in a stagger way relative to each other.

2. The sprocket wheel as claimed in claim 1, wherein said protrusions of each of said supporting devices are symmetric to each other.

3. The sprocket wheel as claimed in claim 1, wherein said protrusions of each of said supporting devices are mirror-symmetric to each other.

4. The sprocket wheel as claimed in claim 1, wherein said protrusions of said supporting devices are formed integral with each other.
